(19) United States
(12) Patent Application Publication
(10) Pub. No.: US 2025/0062562 A1
(43) Pub. Date: Feb. 20, 2025

(54) SHIELD FOR A CONNECTOR INTERFACE AND CONNECTOR ASSEMBLY

(71) Applicant: OUTDOOR WIRELESS NETWORKS LLC, Claremont, NC (US)

(72) Inventors: Lei Tie, Suzhou (CN); ZhaoHui Liu, Suzhou (CN); JianPing Wu, Suzhou (CN)

(21) Appl. No.: 18/776,788

(22) Filed: Jul. 18, 2024

(30) Foreign Application Priority Data
Aug. 14, 2023 (CN) 202322184250.2

(51) Int. Cl. H01R 13/46

(52) U.S. Cl. CPC H01R 13/46

(57) ABSTRACT

The utility model relates to a shield, which is used to wrap at least a part of a cable connector. The shield has a hollow shield body made of elastic material. The shield body surrounds a through-hole for receiving the cable connector and is provided with: multiple circumferential ribs, which are spaced apart from each other in the axial direction and protrude outward in the radial direction; and at least one axial rib, which protrudes outward in the radial direction. The shield of the present utility model can reduce the risk of collapse in the axial direction during the process of installing the shield onto the cable's cable connection portion, thereby improving the installation efficiency. Additionally, the shield according to the present utility model allows for a smaller wall thickness, which helps to reduce manufacturing costs. The present utility model also relates to a connector assembly including the above-mentioned shield.

### CROSS-REFERENCE TO RELATED APPLICATION

The present application claims priority from and the benefit of Chinese Utility Model patent application No. 202322184250.2, filed Aug. 14, 2023, the disclosure of which is hereby incorporated herein by reference in full.

### TECHNICAL FIELD

This utility model generally relates to the field of cable connections. More specifically, it pertains to a shield for a connector interface and connector assembly.

### BACKGROUND ART

Cable connector assemblies used outdoors are susceptible to cyclic expansion and contraction due to factors such as light exposure, moisture, vibration, and daily temperature variations, especially in cable connector assemblies for high-altitude outdoor base station antennas. Various external shields have been used to wrap and protect these cable connector assemblies in current technology.

Existing technology typically employs rigid housing structures (e.g., high-hardness plastic materials) as shields to encase cable connector assemblies, which are difficult to reopen once closed. Therefore, improvements are needed to facilitate the installation and disassembly of the shield. Additionally, with the advancement of communication technology, the application of multi-frequency and multi-port devices has become more widespread, particularly with an increasing number of connection ports on antennas, resulting in a more compact layout of cable connector assemblies. Therefore, it is necessary to design smaller shields to reduce their volume and cost.

### Summary of the Utility Model

The purpose of this utility model is to provide a shield and connector assembly that overcomes at least one defect in existing technology. One aspect of this utility model involves a shield for cable connectors.

One aspect of the present utility model relates to a shield for cable connectors that wraps at least a portion of the cable connector, the shield having a hollow shield body made of an elastomeric material, the shield body surrounding a through hole defining for receiving the cable connector, and the shield body being disposed on an exterior surface thereof:
Multiple circumferential ribs spaced apart from each other in the axial direction and protruding outward in the radial direction; and
at least one axial rib protruding outward in the radial direction.

This shield in the utility model can reduce the risk of collapsing in the axial direction during the installation of the shield on the cable's cable-connection interface, thus improving the installation efficiency. Furthermore, the shield according to this utility model enables a smaller wall thickness, contributing to reduced manufacturing costs.

In some embodiments, the circumferential ribs and/or the axial ribs are integrally formed on the shield body.

In some embodiments, the at least one axial rib consists of multiple axial ribs spaced apart in the circumferential direction.

In some embodiments, the multiple axial ribs are evenly spaced in the circumferential direction.

In some embodiments, the axial rib(s) have at least one of the following features:

Extend in the axial direction or deviate partially from the axial direction.

Extend straight or in a curved manner.

Extend continuously or intermittently.

Extend over a partial axial length of the shield body or along the entire axial length of the shield body.

Have a cross-sectional shape of semi-circular, triangular, trapezoidal, or semi-elliptical when viewed along the axial direction of the shield.

In some embodiments, the height of the axial ribs in the radial direction is between 1 mm and 2 mm, and the width of the axial ribs in the circumferential direction is between 2 mm and 6 mm.

In some embodiments, the shield body comprises a main body and a neck portion set at the far end of the main body, the inner diameter of the neck portion is smaller than the inner diameter of the main body, and the neck portion is constructed to sealably fit onto a mating cable or connector.

In some embodiments, the wall thickness of the main body is between 2 mm and 3 mm.

In some embodiments, the shield body further includes a cable sealing portion disposed at the proximal end of the main body. The cable sealing portion has a tubular shape and a smaller inner diameter than the main body, and it is designed to snugly seal on the cable.

In some embodiments, the inner surface of the cable sealing portion includes recessed portions that do not form a continuous passage from the distal end to the proximal end of the cable sealing portion.

In some embodiments, the recessed portions have a ring-like or helical shape, and they are interrupted at one or more points in the circumferential direction.

In some embodiments, the inner surface of the cable sealing portion includes multiple groups of recessed portions, with each group comprising multiple recessed portions, and adjacent groups are interrupted by a discontinuous portion.

In some embodiments, the discontinuous portion is a part of the inner surface of the cable sealing portion.

In some embodiments, each group of recessed portions includes multiple recessed portions arranged adjacently in the axial direction, and the multiple groups of recessed portions are evenly spaced in the circumferential direction.

In some embodiments, the shield body is made of non-metallic materials.

In some embodiments, the shield body is made of a single material or composite material.

In some embodiments, the shield body is made of a single polymer material or a blend of polymer materials.

Another aspect of the present utility model involves a cable connector assembly, wherein the cable connector assembly comprises:

a cable connector assembly; and

the shield for a connector interface as described above, the shield being configured to enclose at least a portion of the cable connector assembly to protect the connector interface between two mating connectors.

In some embodiments, the cable connector assembly includes an electrical cable connector or an optical cable connector.

In some embodiments, the cable connector is used to connect the ends of cables together.

The above-mentioned technical features, the technical features to be mentioned below, and the technical features shown separately in the drawings can be arbitrarily combined with each other as long as the combined technical features are not mutually contradictory. All feasible combinations of features are expressly disclosed as part of the technical content of this document. Any one of the sub-features contained within the same statement can be independently applied without necessarily being applied together with other sub-features.

### DESCRIPTION OF DRAWINGS

By reference to the accompanying drawings, a detailed description of an exemplary embodiment of the utility model is provided, and other features and advantages of the utility model will become apparent.

FIG. 1 illustrates the front view of a shield according to some embodiments of the utility model.

FIG. 2 illustrates a longitudinal sectional view of the shield taken along line A-A in FIG. 1.

FIG. 3 illustrates a transverse sectional view of the shield taken along line B-B in FIG. 1.

FIG. 4 illustrates a sectional view of the shield when the shield of FIG. 1 and a cable connector assembly are assembled together.

FIG. 5 illustrates a partial sectional view of another embodiment of the shield according to the utility model, showing the construction of the cable sealing part.

FIG. 6 shows a three-dimensional view of the shield from FIG. 5.

### SPECIFIC EMBODIMENTS

It should be noted that in the following description of embodiments, sometimes the same reference numbers are used between different drawings to represent the same part or parts with the same function, and their repetitive explanations are omitted. Similar items are denoted using similar numerals and letters throughout this specification. Therefore, once a certain item is defined in one drawing, it does not need to be further discussed in subsequent drawings.

For the purpose of clarity, the positions, dimensions, and ranges of various structures shown in the drawings may not necessarily represent the actual positions, dimensions, and ranges. Therefore, the disclosed utility model is not limited to the positions, dimensions, and ranges shown in the drawings.

The utility model will be described with reference to the accompanying drawings, where several embodiments of the utility model are illustrated. However, it should be understood that the utility model can be presented in various different ways and is not limited to the embodiments described below. In fact, the embodiments described below aim to make the disclosure of the utility model more complete and to fully explain the scope of protection of the utility model to those skilled in the art. It should also be understood that the disclosed embodiments can be combined in various ways to provide additional embodiments.

It should be understood that the terms used in this specification are used to describe specific embodiments and are not intended to limit the scope of the utility model. All terms used (including technical and scientific terms) have the meaning commonly understood by those skilled in the art unless otherwise defined. For the sake of brevity and/or clarity, well-known functions or structures may not be described in detail.

In this specification, when one component is referred to as being “on,” “attached to,” “connected to,” “coupled to,” or “in contact with” another component, the component may be directly on, attached to, connected to, coupled to, or in contact with the other component, or there may be an intermediate component. In contrast, when one component is referred to as being “directly on,” “directly attached to,” “directly connected to,” “directly coupled to,” or “directly in contact with” another component, there is no intermediate component. In this specification, a feature arranged as “adjacent” to another feature can refer to a feature having a portion that overlaps with the adjacent feature or is located above or below the adjacent feature.

In this document, spatial relational terms such as “above,” “below,” “left,” “right,” “front,” “back,” “high,” “low,” and the like are used to describe the relationship of one feature to another feature in the drawings. It should be understood that spatial relational terms, in addition to the orientations shown in the drawings, also encompass different orientations of the apparatus during use or operation. For example, when the device is flipped in the drawings, a feature previously described as “below” another feature may now be described as “above” the other feature. The device may also be oriented in other ways (e.g., rotated 90 degrees or in other orientations), and the corresponding spatial relationships will be interpreted accordingly.

In this document, the term “A or B” includes “A and B” as well as “A or B,” rather than exclusively meaning “A” or “B” unless otherwise specifically stated.

In this document, the terms “illustrative” or “exemplary” mean “serving as an example, instance, or illustration,” rather than as a “model” to be precisely replicated. Any implementation described in these illustrative examples should not necessarily be interpreted as preferred or advantageous over other implementations in the technical field, background art, content of the utility model, or specific embodiments disclosed herein.

In this document, the term “substantially” means encompassing slight variations resulting from design or manufacturing defects, tolerances of components or elements, environmental influences, and/or other factors.

Additionally, the terms “first,” “second,” and similar terms may be used in this document solely for referencing purposes and are not intended to limit the scope. For example, unless context clearly indicates otherwise, the use of words like “first,” “second,” or other such numerical terms concerning structures or components does not imply any particular order or sequence.

Furthermore, when the term “comprising/including” is used in this document, it indicates the presence of the specified features, steps, operations, units, and/or components but does not exclude the existence or addition of one or more other features, steps, operations, units, and/or components, and/or their combinations.

The present utility model relates to a shield and connector assembly for a cable connector, described in conjunction with various accompanying figures.

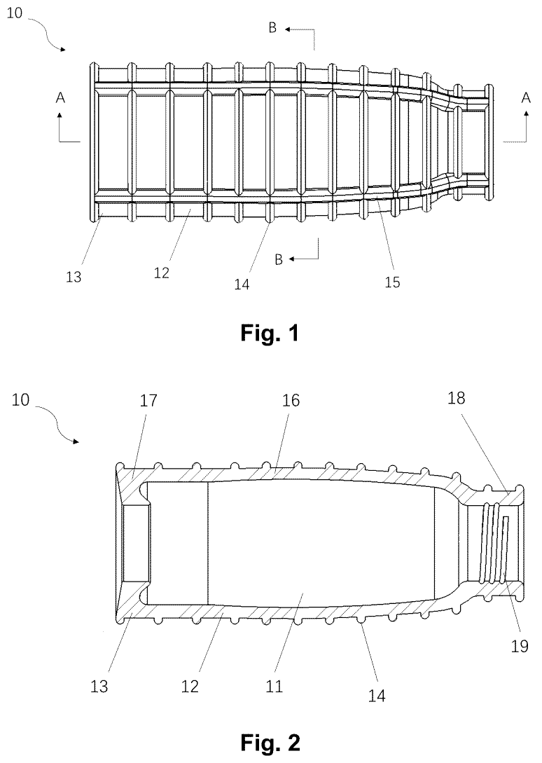

FIG. 1-3 illustrate some embodiments of the shield 10 according to the present utility model. The shield 10 is designed to enclose at least a portion of a cable connector assembly to protect the corresponding interface between two mating connectors. The cable connector assembly may include the cable connector itself and, depending on the application, may involve associated cables, another cable connector, connection panels, and the like. During use, the shield 10 can wrap around or seal the connector interface, preventing water and other external substances from entering the cable. The cable can be, for example, electrical cables, optical cables, or hybrid electrical/optical cables. FIG. 4 shows an example of a connector interface 20 with the shield 10 installed in place. At the cable connector interface 20, the cable connector 21 may connect the cable 22 with another cable (not shown) that is docked to it, or may connect to another connector that is mounted on a piece of telecommunications equipment. The cable 22, the connector 21 and the shield 10 together form a shielded assembly.

As shown in FIG. 1-3, the shield 10 has a hollow shield body 12 that encloses a through hole 11 defining for receiving the cable connector 21. In some embodiments, the shield body 12 can be made of elastic material (e.g., silicone rubber, etc.), allowing the shield 10 to undergo some deformation during installation onto the connector interface 20. In some embodiments, the mentioned elastic material can be non-metallic and may consist of a single material or a composite material. For instance, the elastic material may be a single polymer material or a blended polymer material. Advantageously, the elastic material possesses a certain degree of hardness to maintain the dimensional stability of the shield 10 during installation and use. For example, the shield 10 can be formed integrally through injection molding.

During the installation of the shield 10 onto the connector interface 20, the distal end 13 of the shield 10 can be initially fitted onto the connector interface 20, followed by pushing the shield 10 towards the desired installation position. In this context, “distal” refers to the side away from the operator, while “proximal” refers to the side closer to the operator.

Throughout the description, unless otherwise specified, the term “axial direction” indicates the direction along the length of the shield 10, “circumferential direction” refers to the direction along the circumference of the through-hole 11, and “radial direction” denotes the direction along the diameter of the through-hole 11.

As shown in FIGS. 1 to 3, the outer surface of the shield body 12 can be equipped with multiple circumferential ribs 14. For example, these circumferential ribs 14 can be annular ribs extending in the circumferential direction. These circumferential ribs 14 can form a complete ring in the circumferential direction or consist of multiple separated ring segments. These circumferential ribs 14 can be integrally molded within the shield body 12. These circumferential ribs 14 may be disposed spaced apart from one another in an axial direction and protruding outwardly in the radial direction. The presence of these circumferential ribs 14 facilitates the operator's grip on the shield 10 during the installation process and allows for easier application of pushing force to the shield 10.

As shown in FIG. 1, in some embodiments, the outer surface of the shield body 12 may also feature one or more axial ribs 15, aiding in reducing the risk of collapse in the axial direction while pushing the shield 10 onto the connector interface 20. This contributes to enhanced installation efficiency of the shield 10.

In some embodiments, the axial ribs 15 may extend axially or deviate at least partially from the axial direction. In certain embodiments, the axial ribs 15 may be integrally formed within the shield body 12 and may be set to protrude outward in the radial direction. Multiple axial ribs 15 can be spaced apart from each other in the circumferential direction, for example, equidistantly spaced in the circumferential direction. The number of axial ribs 15 can be, for example, three, four, five, or six.

As shown in FIG. 1, the axial ribs 15 may extend straight in the axial direction and can cover the entire axial length of the shield body 12. In other embodiments not shown, the axial ribs 15 can also extend in a curved manner in the axial direction. In additional embodiments not shown, the axial ribs 15 may only extend along a portion of the axial length of the shield body 12, for example, only along a portion near the far end 13 of the shield body 12. As shown in FIG. 1, each axial rib 15 can be configured to extend continuously in the axial direction. In other embodiments not shown, each axial rib 15 can also be configured to extend intermittently in the axial direction.

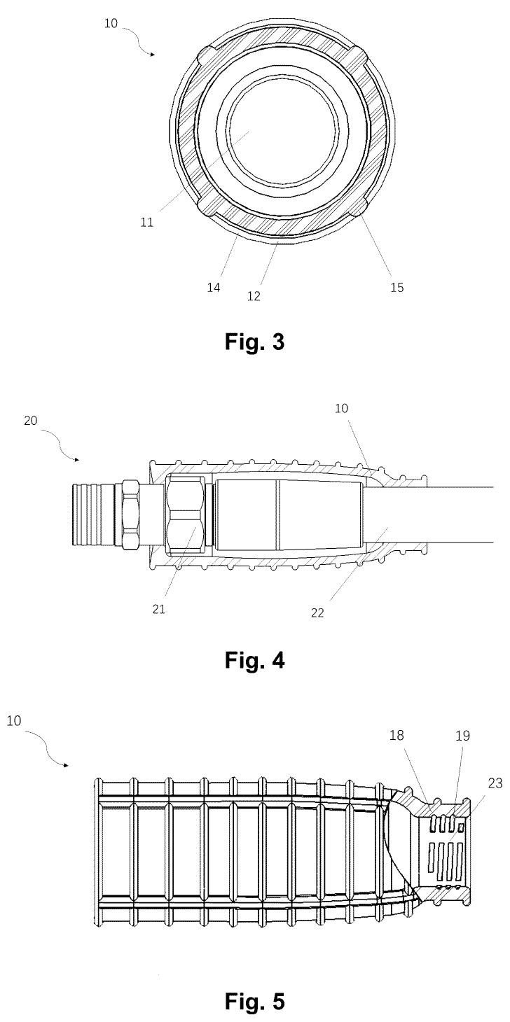

As shown in FIG. 3, when viewed along the axial direction of the shield 10, the axial ribs 15 may have a substantially semi-circular cross-sectional shape. It should be understood that, in other embodiments not shown, the axial ribs 15 may also have other cross-sectional shapes, such as triangular, trapezoidal, semi-elliptical, etc. In some embodiments, the height of the axial ribs 15 in the radial direction can be between 1 mm and 2 mm, and the width of the axial ribs 15 in the circumferential direction can be between 2 mm and 6 mm. It should be understood that the height and width of the axial ribs 15 can be set according to the size of the cable connectors 21 and 22 actually installed in the shield 10.

In the axial direction, the shield body 12 may include a far-side sealing portion and a near-side sealing portion, for sealingly connecting to the far end and near end of shield 10 of the connector interface 20, respectively. For example, as shown in FIG. 2, the shield body 12 may include a main body portion 16 and a neck portion 17 set at the far end of the main body portion 16, which can constitute the far-side sealing portion. The neck portion 17 can be tapered towards the radial inside, so that the inner diameter of the neck portion 17 is smaller than that of the main body portion 16. The inner diameter of the neck portion 17 can be configured to match and sealably connect to the outer diameter of the far end of the connecting segment. For instance, the neck portion 17 can be constructed to snugly seal on the cable connector 21. As shown in FIG. 2, the shield body 12 can also include a cable sealing portion 18 set at the near end of the main body portion 16. The cable sealing portion 18 can be substantially cylindrical and extend a certain length in the axial direction. The inner diameter of the cable sealing portion 18 can be smaller than the inner diameter of the main body portion 16. The inner diameter of the cable sealing portion 18 can be configured to match and sealably connect to the outer diameter of the near end of the connecting segment. For example, the cable sealing portion 18 can be constructed to snugly seal on the cable 22. In some embodiments, the cable sealing portion 18 can have a smaller outer diameter than the outer diameter of the main body portion 16, allowing for a smaller wall thickness at the cable sealing portion 18 to reduce costs.

In some embodiments, the wall thickness of the main body portion 16 can be set between 3 mm and 4.5 mm. Due to the presence of axial ribs 15, during the installation of the shield 10 onto the connector interface 20, the shield 10 is less prone to collapse in the axial direction, thus allowing for a smaller wall thickness of the main body portion 16, for example, reducing it to between 2 mm and 3 mm. For instance, the wall thickness of the main body portion 16 can be set at approximately 2.6 mm. This helps to reduce the manufacturing cost of the shield 10.

As shown in FIG. 2, in some embodiments, the inner surface of the cable seal portion 18 may include recessed portions 19 to facilitate a reduction in the contact area between the inner surface of the cable seal portion 18 and the connector interface 20 during the installation of the shield 10. This reduction in contact area decreases frictional resistance during installation, thereby improving the installation efficiency. The recessed portions 19 can be arranged in a circular or helical pattern along the inner surface of the cable seal portion 18.

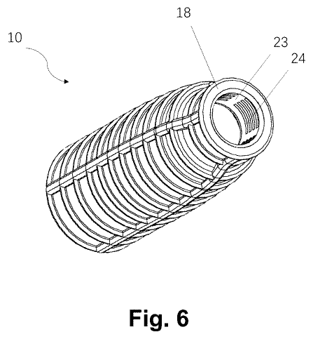

As shown in FIGS. 5 and 6, in some embodiments, within the region between the far-end and near-end of the cable seal portion 18, the recessed portions 19 can be configured to form discontinuous pathways, preventing the ingress of moisture and other substances from the external environment into the interior of the shield 10. For example, the circular or helical recessed portions 19 can be interrupted at one or more interruption points 23 along the circumferential direction. In some embodiments, the inner surface of the cable seal portion 18 can comprise multiple sets of recessed portions 24, each set of recessed portions 24 containing multiple recessed portions 19, and adjacent sets of recessed portions 24 can be interrupted by an interruption point 23. Advantageously, the interruption points 23 can be integral parts of the inner surface of the cable seal portion 18. As further shown in FIGS. 5 and 6, each set of recessed portions 24 can comprise multiple recessed portions 19 arranged adjacently along the axial direction. Multiple sets of recessed portions 24 can be spaced at certain angles along the circumferential direction.

From the foregoing description, it is evident that the present utility model of shield 10 can reduce the risk of axial collapse during its installation onto the connector interface 20, thereby improving the installation efficiency. Additionally, the shield 10 according to the present utility model can have a smaller wall thickness, contributing to lower manufacturing costs, and it can be easily manufactured as an integral unit.

While exemplary embodiments of the present utility model have been described, it should be understood by those skilled in the art that various modifications and changes can be made to the exemplary embodiments of the present utility model without departing from the spirit and scope of the present utility model. Therefore, all modifications and changes are encompassed within the scope of protection defined by the claims of the present utility model. The present utility model is defined by the appended claims, with their equivalents also included therein.

1. A shield for a connector interface, wherein the shield is configured to encase at least a portion of a connector, the shield comprises a hollow shield body made of elastic material, the shield body surrounding a through-hole adapted to receive a cable and the connector, the shield body is further provided with:
multiple circumferential ribs, wherein the multiple circumferential ribs are spaced apart from each other in the axial direction and extend outward in the radial direction; and
at least one axial rib, wherein the axial rib extends outward in the radial direction.

2. The shield for a connector interface according to claim 1, characterized in that the circumferential ribs and/or the axial rib are integrally formed on the shield body.

3. The shield for a connector interface according to claim 1, characterized in that the at least one axial rib comprises multiple axial ribs spaced apart in the circumferential direction.

4. The shield for a connector interface according to claim 3, characterized in that the multiple axial ribs are evenly spaced apart in the circumferential direction.

5. The shield for a connector interface according to claim 1, characterized in that the axial rib has at least one of the following features:
Extending in the axial direction or extending at least partially off the axial direction;
Straight or curved in shape;
Continuous or intermittent;
Extending over a partial axial length of the shield body or extending over the entire axial length of the shield body;
When viewed along the axial direction of the shield, the axial rib has a cross-sectional shape of semi-circular, triangular, trapezoidal, or semi-elliptical.

6. The shield for a connector interface according to claim 1, characterized in that the height of the axial rib in the radial direction is between 1 mm and 2 mm, and the width of the axial rib in the circumferential direction is between 2 mm and 6 mm.

7. The shield for a connector interface according to claim 1, characterized in that the shield body comprises a main body and a neck portion set at the far end of the main body, the inner diameter of the neck portion is smaller than the inner diameter of the main body, and the neck portion is constructed to sealably fit onto a mating cable or connector.

8. The shield for a connector interface according to claim 7, characterized in that the wall thickness of the main body is between 2 mm and 3 mm.

9. The shield for a connector interface according to claim 7, characterized in that the shield body further includes a cable sealing part set at the near end of the main body, the cable sealing part is tubular and has an inner diameter smaller than the inner diameter of the main body, and the cable sealing part is constructed to sealably fit onto the cable.

10. The shield for a connector interface according to claim 9, characterized in that the inner surface of the cable sealing part includes recessed portions, and the recessed portions do not form a continuous passage from the far end to the near end of the cable sealing part.

11. The shield for a connector interface according to claim 10, characterized in that the recessed portions are annular or helical and are interrupted at one or more points in the circumferential direction.

12. The shield for a connector interface according to claim 11, characterized in that the inner surface of the cable sealing part includes multiple sets of recessed portions, each set of recessed portions comprises multiple recessed portions, and adjacent sets of recessed portions are interrupted by a break in the cable sealing part.

13. The shield for a connector interface according to claim 12, characterized in that the break is an integral part of the inner surface of the cable sealing part.

14. The shield for a connector interface according to claim 12, characterized in that each set of recessed portions comprises multiple recessed portions arranged adjacent in the axial direction, and the multiple sets of recessed portions are spaced apart at a certain angle in the circumferential direction.

15. The shield for a connector interface according to claim 1, characterized in that the shield body is made of non-metallic material.

16. The shield for a connector interface according to claim 15, characterized in that the shield body is made of a single material or composite material.

17. The shield for a connector interface according to claim 15, characterized in that the shield body is made of a single polymer material or mixed polymer material.

18. A connector assembly, characterized in that the connector assembly comprises:
a cable connector assembly; and
the shield for a connector interface according to claim 1, the shield being configured to enclose at least a portion of the cable connector assembly to protect the connector interface between two mating connectors.

19. The connector assembly according to claim 18, characterized in that the connector is an electrical cable connector, an optical cable connector, or a hybrid electrical/optical connector.

20. The connector assembly according to claim 18, characterized in that the cable connector is used to connect the ends of cables together.
